(19) United States
(12) Patent Application Publication
(10) Pub. No.: US 2015/0301208 A1
(43) Pub. Date: Oct. 22, 2015

(54) SEISMIC DATA PROCESSING

(71) Applicant: WESTERNGECO L.L.C., HOUSTON, TX (US)

(72) Inventors: WINSTON ROBIN LEWIS, HOUSTON, TX (US); DENES VIGH, HOUSTON, TX (US); RICHARD TIMOTHY COATES, KATY, TX (US)

(21) Appl. No.: 14/258,729

(22) Filed: Apr. 22, 2014

(51) Int. Cl. G01V 1/28; G01V 1/30; G01V 1/38

(52) U.S. Cl. CPC G01V 1/282; G01V 1/3808; G01V 1/303; G01V 1/306

(57) ABSTRACT

Described herein are implementations of various technologies for a method for seismic data processing. The method may receive seismic data for a region of interest. The seismic data may be acquired in a seismic survey. The method may determine a seismic image based on the acquired seismic data and an earth model of the region of interest. The method may determine simulated seismic data based on the earth model. The method may determine an objective function that represents a mismatch between the acquired seismic data and the simulated seismic data. The method may determine a diffusion tensor using geological information from the seismic image. The method may update the earth model using the diffusion tensor with the objective function.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and applicant neither concedes nor acquiesces to the position that any given reference is prior art or analogous prior art.

Seismic exploration may utilize a seismic energy source to generate acoustic signals that propagate into the earth and partially reflect off subsurface seismic reflectors (e.g., interfaces between subsurface layers). The reflected signals are recorded by sensors (e.g., receivers or geophones located in seismic units) laid out in a seismic spread covering a region of the earth's surface. The recorded signals may then be processed to yield a seismic survey.

Accordingly, there is a need for methods and computing systems that can employ more effective and accurate methods for identifying, isolating, and/or processing various aspects of seismic signals or other data that is collected from a subsurface region or other multi-dimensional space.

### SUMMARY

In some implementations, a method for seismic data processing is provided. The method may receive seismic data for a region of interest. The seismic data may be acquired in a seismic survey. The method may determine a seismic image based on the acquired seismic data and an earth model of the region of interest. The method may determine simulated seismic data based on the earth model. The method may determine an objective function that represents a mismatch between the acquired seismic data and the simulated seismic data. The method may determine a diffusion tensor using geological information from the seismic image. The method may update the earth model using the diffusion tensor with the objective function.

In some implementations, the method may determine a gradient of the objective function. The method may also update the gradient of the objective function using the diffusion tensor. The method may update the earth model using the updated gradient.

In some implementations, a method is provided. The method may receive survey data for a multi-dimensional region of interest. The survey data may be acquired in an imaging procedure. The method may determine an image by migrating the survey data into the spatial domain using a model of the multi-dimensional region of interest. The method may determine simulated survey data based at least in part on the model. The method may determine an objective function that represents a mismatch between the survey data and the simulated survey data. The method may determine a diffusion tensor using information obtained from the image. The method may update the model for the multi-dimensional region of interest using the diffusion tensor with the objective function.

The above referenced summary section is provided to introduce a selection of concepts that are further described below in the detailed description section. The summary is not intended to identify features of the claimed subject matter, nor is it intended to be used to limit the scope of the claimed subject matter. Furthermore, the claimed subject matter is not limited to implementations that solve any or most disadvantages noted in any part of this disclosure. Indeed, the systems, methods, processing procedures, techniques, and workflows disclosed herein may complement or replace conventional methods for identifying, isolating, and/or processing various aspects of seismic signals or other data that is collected from a subsurface region or other multi-dimensional space, including time-lapse seismic data collected in a plurality of surveys.

### BRIEF DESCRIPTION OF THE DRAWINGS

Implementations of various technologies will hereafter be described with reference to the accompanying drawings. It should be understood, however, that the accompanying drawings illustrate various implementations described herein and are not meant to limit the scope of various technologies described herein.

FIG. 1 illustrates a diagrammatic view of marine seismic surveying in accordance with various implementations described herein.

FIG. 2 illustrates a flow diagram of a method for processing seismic data in accordance with various implementations described herein.

FIG. 3 illustrates a flow diagram of a method for determining a diffusion tensor in accordance with various implementations described herein.

FIG. 4 illustrates a computer system in which the various technologies and techniques described herein may be incorporated and practiced.

### DETAILED DESCRIPTION

The discussion below is directed to certain specific implementations. It is to be understood that the discussion below is for the purpose of enabling a person with ordinary skill in the art to make and use any subject matter defined now or later by the patent “claims” found in any issued patent herein.

Reference will now be made in detail to various implementations, examples of which are illustrated in the accompanying drawings and figures. In the following detailed description, numerous specific details are set forth in order to provide a thorough understanding of the claimed invention. However, it will be apparent to one of ordinary skill in the art that the claimed invention may be practiced without these specific details. In other instances, well known methods, procedures, components, circuits, and networks have not been described in detail so as not to unnecessarily obscure aspects of the claimed invention.

It will also be understood that, although the terms first, second, etc., may be used herein to describe various elements, these elements should not be limited by these terms. These terms are used to distinguish one element from another. For example, a first object or block could be termed a second object or block, and, similarly, a second object or block could be termed a first object or block, without departing from the scope of the invention. The first object or block, and the second object or block, are both objects or blocks, respectively, but they are not to be considered the same object or block.

The terminology used in the description herein is for the purpose of describing particular implementations and is not intended to limit the claimed invention. As used herein, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises,” and/or “comprising,” when used in this specification, specify the presence of stated features, integers, blocks, operations, elements, and/or components, but do not preclude the presence or addition of one or more other features, integers, blocks, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

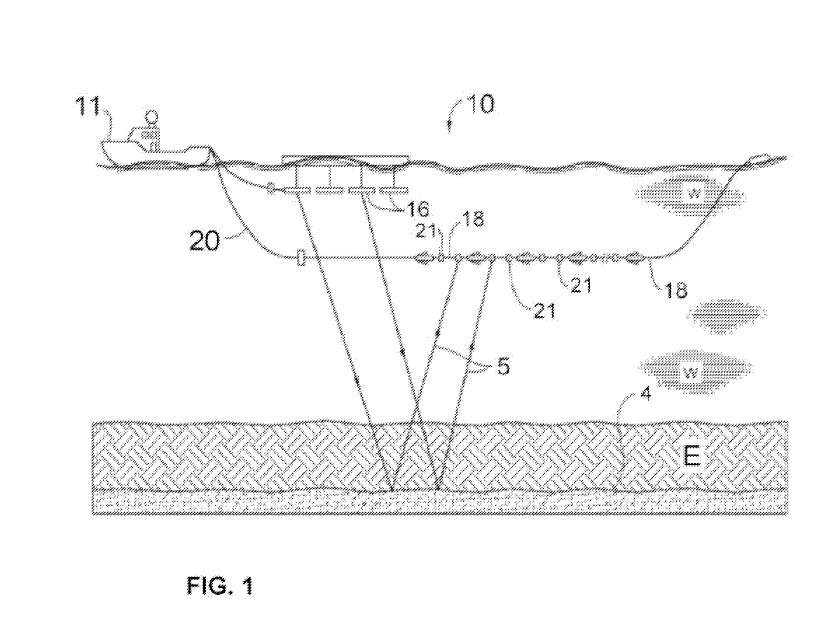

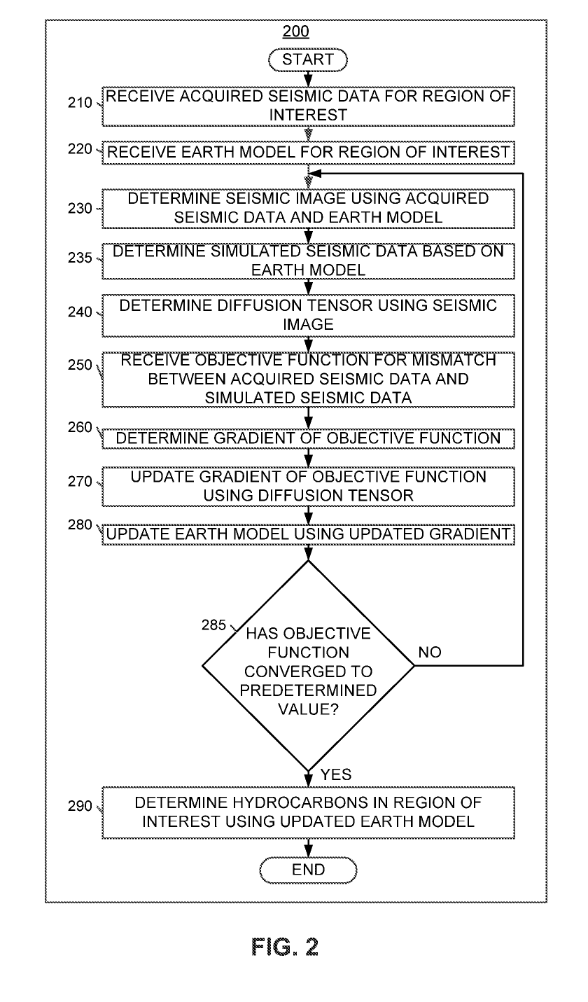

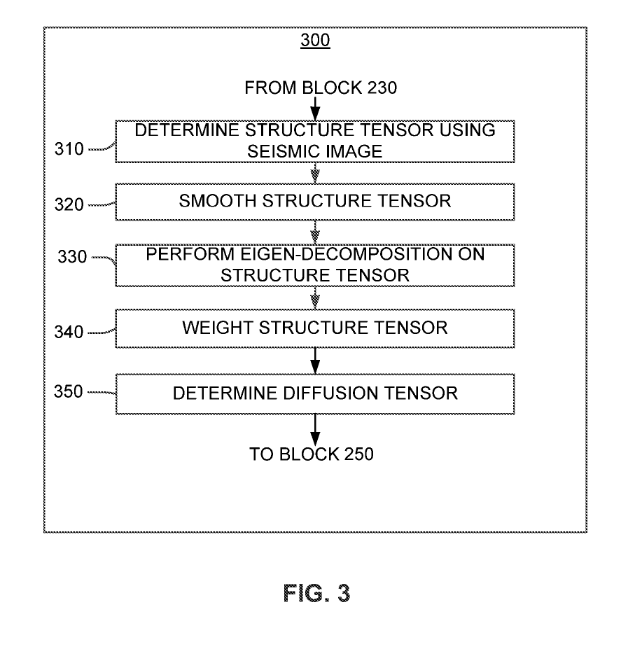

Full-waveform inversion (FWI) may describe a process of forward modeling a seismic response of the subsurface using an estimated elastic property earth model. In full-waveform inversion, a mismatch between observed seismic data and simulated seismic data (also called “synthetic seismic data”) is measured, while an estimated earth model may be optimized through an iterative method until the mismatch converges to a predetermined value, such as a global optimum. Various techniques described herein are directed to updating an earth model using a diffusion tensor based on geological information from a seismic image. Observed seismic data may be data acquired by a seismic survey as described in FIG. 1. FIGS. 2 and 3 describe a method of performing full-waveform inversion.

FIG. 1 illustrates a diagrammatic view of marine seismic surveying 10 in connection with implementations of various techniques described herein. A marine seismic acquisition system 10 may include a vessel 11 carrying control components and towing a plurality of seismic sources 16 and a plurality of streamers 18 equipped with seismic receivers 21. The seismic sources 16 may include a single type of source, or different types. The sources may use any type of seismic generator, such as air guns, water guns, steam injection sources, controllable seismic sources, explosive sources such as dynamite or gas injection followed by detonation and the like. The streamers 18 may be towed by means of their respective lead-ins 20, which may be made from high strength steel or fiber-reinforced cables that convey electrical power, control, and data signals between the vessel 11 and the streamers 18. An individual streamer may include a plurality of seismic receivers 21 that may be distributed at spaced intervals along the streamer's length. The seismic receivers 21 may include hydrophone sensors as well as multi-component sensor devices, such as accelerometers. Further, the streamers 18 may include a plurality of inline streamer steering devices (SSDs), also known as “birds.” The SSDs may be distributed at appropriate intervals along the streamers 18 for controlling the streamers' depth and lateral movement. A single survey vessel may tow a single receiver array along individual sail lines, or a plurality of survey vessels may tow a plurality of receiver arrays along a corresponding plurality of the sail lines.

During acquisition, the seismic sources 16 and the seismic streamers 18 may be deployed from the vessel 11 and towed slowly to traverse a region of interest. The seismic sources 16 may be periodically activated to emit seismic energy in the form of an acoustic or pressure wave through the water. The sources 16 may be activated individually or substantially simultaneously with other sources. The acoustic wave may result in one or more seismic wavefields that travel coherently into the earth E underlying the water W. As the wavefields strike interfaces 4 between earth formations, or strata, they may be reflected back through the earth E and water W along paths 5 to the various receivers 21 where the wavefields (e.g., pressure waves in the case of air gun sources) may be converted to electrical signals, digitized and transmitted to the integrated computer-based seismic navigation, source controller, and recording system in the vessel 11 via the streamers 18 and lead-ins 20. Through analysis of these detected signals, it may be possible to determine the shape, position and lithology of the sub-sea formations, including those formations that may include hydrocarbon deposits. While a marine seismic survey is described in regard to FIG. 1, implementations of various techniques described herein may also be used in connection to a land seismic survey.

FIG. 2 illustrates a flow diagram of a method for processing seismic data in accordance with various implementations described herein. It should be understood that while the operational flow diagram indicates a particular order of execution of the operations, in other implementations, the operations might be executed in a different order. Further, in some implementations, additional operations or blocks may be added to the method. Likewise, some operations or blocks may be omitted.

At block 210, seismic data are received for a region of interest (i.e., “the received seismic data” and also called “observed seismic data” or “acquired seismic data”). For instance, the seismic data may be data acquired from a seismic survey as described in FIG. 1. The region of interest may include an area of the subsurface in the earth that may be of particular interest, such as for hydrocarbon production.

At block 220, an earth model may be received for the region of interest (i.e., “the received earth model”). For instance, the received earth model may be a velocity model or an anisotropic model that describes the region of interest. As such, the received earth model may include elastic properties for specific regions in the subsurface of the earth. Elastic properties may include density, P-velocity (Vp) or velocity of the primary wave, S-velocity (Vs) or velocity of the shear wave, acoustic impedance, shear impedance, Poisson's ratio, or a combination thereof.

At block 230, a seismic image may be determined using the received earth model and the received seismic data. For instance, the received seismic data may be in an inversion domain, such as the time-domain, and the received seismic data may be migrated from the inversion domain into the depth-domain. As such, the seismic image may provide a mapped geological representation of the subsurface for the region of interest. An example of a seismic image may include a depth slice or an in-line slice of the subsurface.

At block 235, simulated seismic data may be determined based on the received earth model. The simulated seismic data may be determined using the received earth model to simulate a seismic survey corresponding to the received seismic data at block 210.

At block 240, a diffusion tensor may be determined using the seismic image at block 230. The diffusion tensor may be used to solve an anisotropic diffusion equation, such as the one described below in Equation 5. As such, the diffusion tensor may be a structure tensor that is modified using geological information obtained from the seismic image. For more information regarding a structure tensor, see block 310 below.

FIG. 3 illustrates a method 300 for determining a diffusion tensor. It should be understood that while the operational flow diagram indicates a particular order of execution of the operations, in other implementations, the operations might be executed in a different order. Further, in some implementations, additional operations or blocks may be added to the method. Likewise, some operations or blocks may be omitted.

At block 310, a structure tensor may be determined (i.e., “the determined structure tensor”) using the seismic image determined at block 230. A structure tensor may be a representation, such as a matrix, that includes partial derivative data regarding an image, such as the seismic image determined at block 230. Partial derivative data may include gradient or edge information regarding the seismic image, for example. In one implementation, a structure tensor S(x) may be determined using the following equation:

S(x)=∇I/(x)∇I(x)^{T} Equation 1

where I(x) is the seismic image, ∇I(x) is the gradient of the seismic image, ∇I(x)^{T} is the transpose of the gradient of the seismic image, and x is an image point or pixel in the seismic image.

At block 320, the determined structure tensor is smoothed. For instance, a smoothing parameter may be applied to the determined structure tensor from block 310 to produce a smoothed structure tensor. The smoothing parameter may be defined by a user and may correspond to a spatial window for the determined structure tensor. A spatial window may specify the corresponding physical dimensions of geological features, such as those at a particular pixel or image point in the seismic image, for use in modifying or configuring the determined structure tensor, for instance, to determine the gradient at a particular image point. As such, the spatial window may specify the corresponding area in space that a pixel may represent for defining which structural information or partial derivative information is used in the determined structure tensor. In one implementation, the spatial window may be a Gaussian window. For instance, a smoothed structure tensor S_{σ}(x) may be determined by the following equation:

S_{σ}(x)=G_{σ}*S(x) Equation 2

where G_{σ} is the smoothing parameter that defines a Gaussian window, S(x) is the determined structure tensor from block 310, * is the convolution operator, and x is an image point on the seismic image.

At block 330, an eigen-decomposition is performed on the determined structure tensor from blocks 310 or 320. In an eigen-decomposition, the determined structure tensor may be decomposed into eigen-values and eigen-vectors at a given image point x. As such, the eigen-decomposition may weight the directions regarding how the seismic image may change at a particular image point to facilitate smoothing along directions that exhibit little heterogeneity in the seismic image while inhibiting smoothing that is normal to geological boundaries, such as across reflection interfaces. In one instance, an eigen-decomposition may be used to preserve edges (e.g., at a reflection interface or a fault) and other structural boundaries within a seismic image. In the earth's subsurface, elastic properties may change faster across a layer (e.g., by crossing a reflective interface) than along the layer. In regard to the layering of the surface, the eigen-decomposition may account for this natural bedding process of the subsurface in performing the eigen-decomposition on the determined structure tensor. In one implementation, an eigen-decomposition of the determined structure tensor may be performed using the following equation:

S(x)=Σγᵢ(x)eᵢeᵢ^{T} Equation 3

where i refers to the three different spatial dimensions (i.e., x-dimension, y-dimension and z-dimension), eᵢ is the eigen-vector at the i^{th} dimension, eᵢ^{T} is the transpose of the eigen-vector for the i^{th} dimension, and γᵢ(x) represents the eigen-values for the i^{th} dimension.

At block 340, the determined structure tensor from blocks 310, 320 or 330 is weighted to preserve attributes of various geological structures inside a seismic image. Examples of geological structures may include geological faults, channels, or salt bodies located inside a subsurface layer. In one implementation, the determined structure tensor may be weighted as shown in the following equation:

S(x)=Σwᵢ(x)γᵢ(x)eᵢeᵢ^{T} Equation 4

where i refers to the three different spatial dimensions (i.e., x-dimension, y-dimension and z-dimension), eᵢ is the eigenvector at the i^{th} dimension, eᵢ^{T} is the transpose of the eigenvector for the i^{th} dimension, γᵢ(x) represents the eigenvalues for the i^{th} dimension, and wᵢ(x) represents weights for geological structures for the i^{th} dimension.

At block 350, a diffusion tensor is determined from blocks 310, 320, 330 and/or 340 for solving an anisotropic diffusion equation. Anisotropic diffusion may be a process that eliminates noise or model inaccuracies through the diffusion of image points between preserved structural boundaries, such as lines or edges inside an image. As such, the diffusion tensor may be used to perform this diffusion process by solving a partial derivative equation (PDE) or the anisotropic diffusion equation. An example of a diffusion tensor may be a positive definite symmetric matrix. In one implementation, an anisotropic diffusion equation may be the following equation:

$$\frac{\partial u ( x )}{\partial t} = ▽ \cdot D ( x ) ▽ u ( x ) \qquad Equation 5$$

where u(x) is an image (e.g., the seismic image), D(x) is the determined diffusion tensor at image point x, ∇u(x) is the gradient of the image at the image point x, and

$$\frac{\partial u ( x )}{\partial t}$$

is the diffusion of the image with respect to time t.

Furthermore, blocks 310, 320, 330 and 340 may be combined into the following equation:

S_{σ}(x)=G_{σ} [symbol] ∇I(x)∇I(x)^{T} Equation 6

Other implementations besides those described above may be used to determine a diffusion tensor for the seismic image. In one implementation, the diffusion tensor may be determined using a dip field derived from the seismic image at block 230. In another implementation, the diffusion tensor may be determined from user interpretation of the seismic image. As such, the diffusion tensor may be determined without performing an eigen-decomposition on the structure tensor as described at block 330.

Returning to FIG. 2, at block 250, an objective function is received (i.e., “the received objective function”). The received objective function may represent the mismatch between the received seismic data at block 210 and the simulated data at block 235. As such, the received objective function may refer to both the relationship between the received seismic data and the simulated data, as described in Equation 7 below, and/or the measured mismatch between the received seismic data and the simulated seismic data.

Furthermore, the received objective function may provide a solution to a seismic inverse problem, such as one used for full-waveform inversion. In full-waveform inversion, a forward modeling operator F(m) may map the received earth model over an inversion domain Ω to a data domain, thereby producing forward modeled data. To obtain a solution for the inverse problem, full-waveform inversion may include an optimization process to minimize the mismatch f(m) between the forward modeled data and observed seismic data, as described by the received objective function. For instance, the received objective function may be expressed by the following equation:

minf(m)=½∥F(m)−d∥₂² Equation 7

where m includes parameters (e.g., elastic properties) of the received earth model, F(m) is the forward modeling operator based on the earth model that maps the seismic response of the subsurface, and d is the observed seismic data. F(m) may be the simulated seismic data from block 235 and d may be the received seismic data at block 210. However, many different solutions may exist for the received objective function at Equation 7.

In one implementation, the received objective function may be a regularized objective function. Regularization may be used to stabilize the solution of an objective function for a seismic inverse problem by reducing the size of the possible null space for the seismic inverse problem, which may reduce the amount of possible solutions. Regularization may include introducing priori information into an objective function. Priori information may include inferences about an inverse problem that may be made based on the particular physics of the problem, such as the natural bedding process of the subsurface. In one implementation, a regularized objective function may be expressed by the following equation:

minf(m)=½∥F(m)−d∥₂²+λJ(m) Equation 8

where m includes properties from an earth model, F(m) is the forward-modeled seismic response based on the earth model, d is the observed seismic data, λ is a user-defined regularization weight, and J(m) is regularization function based on the earth model and priori information. J(m) may be specified using the following equation:

J(m)=½∫_{Ω}h[∥∇m∥²] Equation 9

where Ω is the seismic inversion domain, m includes parameters of the received earth model, ∇m is the spatial gradient vector of the model parameter m, and h describes a compactly supported infinitely differentiable function.

At block 260, the gradient of the received objective function may be determined. For instance, in full-waveform inversion, the gradient of the received objective function g(m) may be expressed by the following equation:

g(m)=∇f(m) Equation 10

The gradient g(m) may be computed by any applicable method, such as the adjoint-state formulation. For instance, in an adjoint-state formulation, state variables (e.g., the seismic wavefield variables) may be computed by forward modeling the seismic response of the subsurface. Then, an adjoint source may be computed for the state variables and the received objective function. Next, the adjoint state variables (e.g., the seismic wavefields from the adjoint source) may be computed by backward modeling the seismic wavefields. Finally, the gradient of the received objective function may be computed using the state variables and the adjoint state variables.

At block 270, the gradient of the received objective function is updated (i.e., “the updated gradient of the received objective function” or “the pre-conditioned gradient”) using the diffusion tensor determined at block 250. For instance, the diffusion tensor may be used to solve an anisotropic diffusion equation. The anisotropic diffusion equation may be similar to the one described at block 350, such as Equation 5, or the following equation:

$$\frac{\partial \hat{g} ( x )}{\partial t} = ▽ \cdot D ( x ) ▽ \hat{g} ( x ) \qquad Equation 11$$

where D(x) is the determined diffusion tensor from block 250 and ĝ(x) is the updated gradient of the received objective function as a function of an image point x in the seismic image.

The updated gradient of the received objective function ĝ(m) may be determined using the following equation:

∇\hat{f}(m)=\hat{g}(m)=g(m)+λJ(m) Equation 12

where g(m) is the gradient of the received objective function from block 260, such as the one shown by Equations 7 or 8, λ is the user defined regularization weight, and J(m) is the regularization function, for instance, as described by Equation 9 above.

At block 280, the received earth model is updated using the updated gradient of the received objective function from block 270. The received earth model may be updated iteratively, such as according to the rule in mₖ₊₁=mₖ+aₖpₖ, where mₖ is the received earth model at iteration k, αₖ is the step size or length determined by a line search procedure with the search direction pₖ, and mₖ₊₁ is the updated earth model. The search direction pₖ may be selected using the updated gradient of the received objective function and the selected optimization technique that is being used, such as one of steepest descent, conjugate gradient, or Newton/quasi-Newton directions. The step length corresponds to the amount of change for model parameters in the updated earth model.

At block 285, it is determined whether the received objective function has converged to a predetermined value. For instance, the predetermined value may be a global optimum for the updated earth model. The predetermined value may also be a specified threshold where convergence occurs when the difference between the received seismic data and the simulated data at block 235 is below the specified threshold. The specified threshold may be submitted by a user. If the received objective function has converged to the predetermined value, the process may proceed to block 290. If the received objective function has not converged, the process may return to block 230 to repeat one or more of blocks 230-285 using the updated earth model from block 280 in place of the received earth model from block 220.

At block 290, the updated earth model may be used to determine the presence of hydrocarbons in the region of interest. For instance, the updated earth model may be used to facilitate hydrocarbon exploration or production. In one implementation, a petrophysical model may be estimated based on a final earth model from block 285. The petrophysical model may include various petrophysical properties that describe the region of interest such as the amount of shale (Vshale), the elastic moduli of composite rock or the density of the solid phase of rock.

In some implementations, a method for seismic data processing is provided. The method may receive seismic data for a region of interest. The seismic data may be acquired in a seismic survey. The method may determine a seismic image based on the acquired seismic data and an earth model of the region of interest. The method may determine simulated seismic data based on the earth model. The method may determine an objective function that represents a mismatch between the acquired seismic data and the simulated seismic data. The method may determine a diffusion tensor using geological information from the seismic image. The method may update the earth model using the diffusion tensor with the objective function.

In some implementations, the method may determine a gradient of the objective function. The method may also update the gradient of the objective function using the diffusion tensor. The method may update the earth model using the updated gradient.

In some implementation, the method may solve an anisotropic diffusion equation using the tensor. The method may also determine a spatial window for the diffusion tensor. The spatial window may specify the corresponding physical dimensions of geological features in the seismic image used in updating the gradient of the objective function. The diffusion tensor may be determined from a structure tensor of the seismic image. The method may perform an eigen-decomposition on the structure tensor. The method may weight the diffusion tensor to preserve structural boundaries from the region of interest. The simulated data may be determined by performing a computer simulation of the seismic survey using the earth model. The seismic image may describe the acquired seismic data in the depth-domain. The objective function may be a regularized objective function that includes priori information based on the earth model. The method may use the updated earth model to facilitate hydrocarbon exploration or production. The earth model may include elastic properties such as density, P-velocity (Vp), S-velocity (Vs), acoustic impedance, shear impedance, Poisson's ratio or a combination thereof. The method may use a search direction and a step size found by a line search method to update elastic property values in the earth model.

In some implementations, an information processing apparatus for use in a computing system is provided, and includes means for receiving seismic data for a region of interest. The seismic data may be acquired in a seismic survey. The information processing apparatus may also have means for determining a seismic image based on the acquired seismic data and an earth model of the region of interest. The information processing apparatus may also have means for determining simulated seismic data based on the earth model. The information processing apparatus may also have means for determining an objective function that represents a mismatch between the acquired seismic data and the simulated seismic data. The information processing apparatus may also have means for determining a diffusion tensor using geological information from the seismic image. The information processing apparatus may also have means for determining a diffusion tensor using geological information from the seismic image. The information processing apparatus may also have means for updating the earth model using the diffusion tensor with the objective function.

In some implementations, a computing system is provided that includes at least one processor, at least one memory, and one or more programs stored in the at least one memory, wherein the programs include instructions, which when executed by the at least one processor cause the computing system to receive seismic data for a region of interest. The seismic data may be acquired in a seismic survey. The programs may further include instructions to cause the computing system to determine a seismic image based on the acquired seismic data and an earth model of the region of interest. The programs may further include instructions to cause the computing system to determine simulated seismic data based on the earth model. The programs may further include instructions to cause the computing system to determine an objective function that represents a mismatch between the acquired seismic data and the simulated seismic data. The programs may further include instructions to cause the computing system to determine a diffusion tensor using geological information from the seismic image. The programs may further include instructions to cause the computing system to update the earth model using the diffusion tensor with the objective function.

In some implementations, a computer readable storage medium is provided, which has stored therein one or more programs, the one or more programs including instructions, which when executed by a processor, cause the processor to receive seismic data for a region of interest. The seismic data may be acquired in a seismic survey. The programs may further include instructions, which cause the processor to determine simulated seismic data based on the earth model. The programs may further include instructions, which cause the processor to determine an objective function that represents a mismatch between the acquired seismic data and the simulated seismic data. The programs may further include instructions, which cause the processor to determine a diffusion tensor using geological information from the seismic image. The programs may further include instructions, which cause the processor to update the earth model using the diffusion tensor with the objective function.

In some implementations, a method for processing data corresponding to a multi-dimensional region of interest is provided. The method may receive survey data for a multi-dimensional region of interest. The method may determine an image by migrating the survey data into the spatial domain using a model of the multi-dimensional region of interest. The method may determine simulated survey data based on the model. The method may determine an objective function that represents a mismatch between the survey data and the simulated survey data. The method may determine a diffusion tensor using information obtained from the image. The method may update the model for the multi-dimensional region of interest using the diffusion tensor with the objective function.

In some implementations, an information processing apparatus for use in a computing system is provided, and includes means for receiving survey data for a multi-dimensional region of interest. The information processing apparatus may also have means for determining an image by migrating the survey data into the spatial domain using a model of the multi-dimensional region of interest. The information processing apparatus may also have means for determining simulated survey data based on the model. The information processing apparatus may also have means for determining an objective function that represents a mismatch between the survey data and the simulated survey data. The information processing apparatus may also have means for determining a diffusion tensor using information obtained from the image. The information processing apparatus may also have means for updating the model for the multi-dimensional region of interest using the diffusion tensor with the objective function.

In some implementations, a computing system is provided that includes at least one processor, at least one memory, and one or more programs stored in the at least one memory, wherein the programs include instructions, which when executed by the at least one processor cause the computing system to receive survey data for a multi-dimensional region of interest. The programs may further include instructions to cause the computing system to determine an image by migrating the survey data into the spatial domain using a model of the multi-dimensional region of interest. The programs may further include instructions to cause the computing system to determine simulated survey data based on the model. The programs may further include instructions to cause the computing system to determine an objective function that represents a mismatch between the survey data and the simulated survey data. The programs may further include instructions to cause the computing system to determine a diffusion tensor using information obtained from the image. The programs may further include instructions to cause the computing system to update the model for the multi-dimensional region of interest using the diffusion tensor with the objective function.

In some implementations, a computer readable storage medium is provided, which has stored therein one or more programs, the one or more programs including instructions, which when executed by a processor, cause the processor to receive survey data for a multi-dimensional region of interest. The programs may further include instructions, which cause the processor to determine an image by migrating the survey data into the spatial domain using a model of the multi-dimensional region of interest. The programs may further include instructions, which cause the processor to determine simulated survey data based on the model. The programs may further include instructions, which cause the processor to determine an objective function that represents a mismatch between the survey data and the simulated survey data. The programs may further include instructions, which cause the processor to determine a diffusion tensor using information obtained from the image. The programs may further include instructions, which cause the processor to update the model for the multi-dimensional region of interest using the diffusion tensor with the objective function.

In some implementations, the multi-dimensional region of interest is selected from the group consisting of a subterranean region, human tissue, plant tissue, animal tissue, solid volumes, substantially solid volumes, volumes of liquid, volumes of gas, volumes of plasma, and volumes of space near and/or outside the atmosphere of a planet, asteroid, comet, moon, or other body.

In some implementations, the multi-dimensional region of interest includes one or more volume types selected from the group consisting of a subterranean region, human tissue, plant tissue, animal tissue, solid volumes, substantially solid volumes, volumes of liquid, volumes of air, volumes of plasma, and volumes of space near and/or or outside the atmosphere of a planet, asteroid, comet, moon, or other body.

### Computing System

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smartphones, smartwatches, personal wearable computing systems networked with other computing systems, tablet computers, and distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc., that performs particular tasks or implement particular abstract data types. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. The distributed computing environments may span multiple continents and multiple vessels, ships or boats. In a distributed computing environment, program modules may be located in both local and remote computer storage media including memory storage devices.

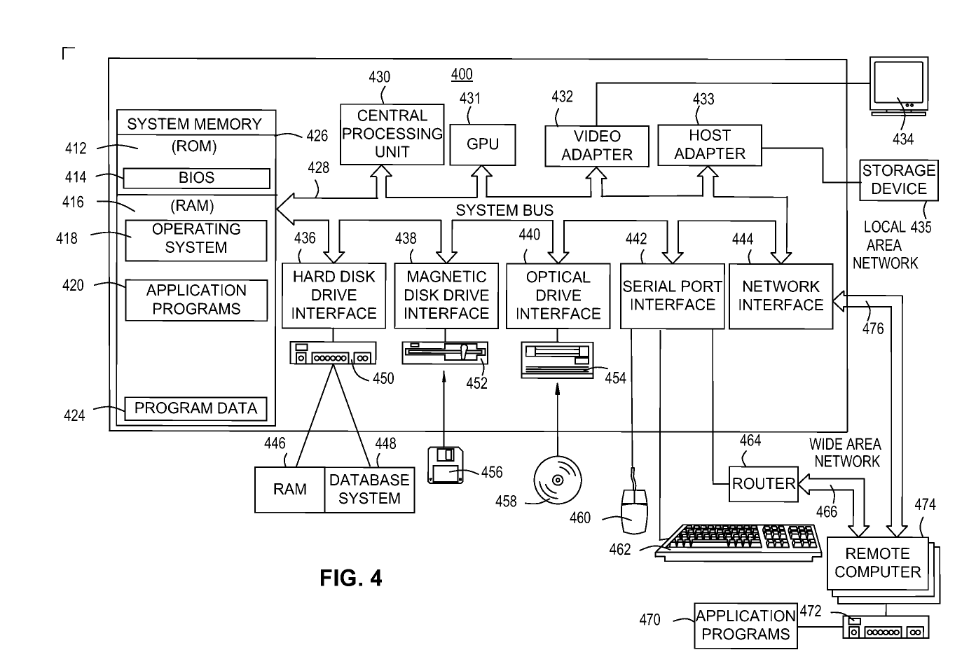

FIG. 4 illustrates a schematic diagram of a computing system 400 in which the various technologies described herein may be incorporated and practiced. Although the computing system 400 may be a conventional desktop or a server computer, as described above, other computer system configurations may be used.

The computing system 400 may include a central processing unit (CPU) 430, a system memory 426, a graphics processing unit (GPU) 431 and a system bus 428 that couples various system components including the system memory 426 to the CPU 430. Although one CPU is illustrated in FIG. 4, it should be understood that in some implementations the computing system 400 may include more than one CPU. The GPU 431 may be a microprocessor specifically designed to manipulate and implement computer graphics. The CPU 430 may offload work to the GPU 431. The GPU 431 may have its own graphics memory, and/or may have access to a portion of the system memory 426. As with the CPU 430, the GPU 431 may include one or more processing units, and the processing units may include one or more cores. The system bus 428 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 426 may include a read-only memory (ROM) 412 and a random access memory (RAM) 416. A basic input/output system (BIOS) 414, containing the basic routines that help transfer information between elements within the computing system 400, such as during start-up, may be stored in the ROM 412.

The computing system 400 may further include a hard disk drive 450 for reading from and writing to a hard disk, a magnetic disk drive 452 for reading from and writing to a removable magnetic disk 456, and an optical disk drive 454 for reading from and writing to a removable optical disk 458, such as a CD ROM or other optical media. The hard disk drive 450, the magnetic disk drive 452, and the optical disk drive 454 may be connected to the system bus 428 by a hard disk drive interface 436, a magnetic disk drive interface 438, and an optical drive interface 440, respectively. The drives and their associated computer-readable media may provide nonvolatile storage of computer-readable instructions, data structures, program modules and other data for the computing system 400.

Although the computing system 400 is described herein as having a hard disk, a removable magnetic disk 456 and a removable optical disk 458, it should be appreciated by those skilled in the art that the computing system 400 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 400. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 400 may also include a host adapter 433 that connects to a storage device 435 via a small computer system interface (SCSI) bus, a Fiber Channel bus, an eSATA bus, or using any other applicable computer bus interface. Combinations of any of the above may also be included within the scope of computer readable media.

A number of program modules may be stored on the hard disk 450, magnetic disk 456, optical disk 458, ROM 412 or RAM 416, including an operating system 418, one or more application programs 420, program data 424, and a database system 448. The application programs 420 may include various mobile applications (“apps”) and other applications configured to perform various methods and techniques described herein. The operating system 418 may be any suitable operating system that may control the operation of a networked personal or server computer, such as Windows® XP, Mac OS® X, Unix-variants (e.g., Linux® and BSD®), and the like.

A user may enter commands and information into the computing system 400 through input devices such as a keyboard 462 and pointing device 460. Other input devices may include a microphone, joystick, game pad, satellite dish, scanner, or the like. These and other input devices may be connected to the CPU 430 through a serial port interface 442 coupled to system bus 428, but may be connected by other interfaces, such as a parallel port, game port or a universal serial bus (USB). A monitor 434 or other type of display device may also be connected to system bus 428 via an interface, such as a video adapter 432. In addition to the monitor 434, the computing system 400 may further include other peripheral output devices such as speakers and printers.

Further, the computing system 400 may operate in a networked environment using logical connections to one or more remote computers 474. The logical connections may be any connection that is commonplace in offices, enterprise-wide computer networks, intranets, and the Internet, such as local area network (LAN) 476 and a wide area network (WAN) 466. The remote computers 474 may be another a computer, a server computer, a router, a network PC, a peer device or other common network node, and may include many of the elements describes above relative to the computing system 400. The remote computers 474 may also each include application programs 470 similar to that of the computer action function.

When using a LAN networking environment, the computing system 400 may be connected to the local network 476 through a network interface or adapter 444. When used in a WAN networking environment, the computing system 400 may include a router 464, wireless router or other means for establishing communication over a wide area network 466, such as the Internet. The router 464, which may be internal or external, may be connected to the system bus 428 via the serial port interface 442. In a networked environment, program modules depicted relative to the computing system 400, or portions thereof, may be stored in a remote memory storage device 435. It will be appreciated that the network connections shown are merely examples and other means of establishing a communications link between the computers may be used.

The network interface 444 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 474.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Also, the program code may execute entirely on a user's computing device, partly on the user's computing device, as a stand-alone software package, partly on the user's computer and partly on a remote computer or entirely on the remote computer or a server computer.

Those with skill in the art will appreciate that any of the listed architectures, features or standards discussed above with respect to the example computing system 400 may be omitted for use with a computing system used in accordance with the various embodiments disclosed herein because technology and standards continue to evolve over time.

Of course, many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a three-dimensional space and/or subsurface region of interest may be collected and processed, e.g., medical imaging techniques such as tomography, ultrasound, MRI and the like for human tissue; radar, sonar, and LIDAR imaging techniques; and other appropriate three-dimensional imaging problems.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

What is claimed is:

1. A method for seismic data processing, comprising:
receiving seismic data for a region of interest, wherein the seismic data is acquired in a seismic survey;
determining a seismic image based at least in part on the acquired seismic data and an earth model of the region of interest;
determining simulated seismic data based at least in part on the earth model;
determining an objective function that represents a mismatch between the acquired seismic data and the simulated seismic data;
determining a diffusion tensor using geological information from the seismic image; and
updating the earth model using the diffusion tensor with the objective function.

2. The method of claim 1, wherein updating the earth model using the diffusion tensor comprises:
determining a gradient of the objective function;
updating the gradient of the objective function using the diffusion tensor; and
updating the earth model using the updated gradient.

3. The method of claim 2, wherein updating the gradient of the objective function comprises solving an anisotropic diffusion equation using the diffusion tensor.

4. The method of claim 2, wherein updating the earth model further comprises iteratively updating the earth model and the gradient of the objective function until the objective function converges to a predetermined value.

5. The method of claim 1, wherein determining the diffusion tensor comprises determining a spatial window for the diffusion tensor, wherein the spatial window specifies the corresponding physical dimensions of geological features in the seismic image used in updating the gradient of the objective function.

6. The method of claim 1, wherein the diffusion tensor is determined from a structure tensor of the seismic image.

7. The method of claim 6, wherein determining the diffusion tensor comprises performing an eigen-decomposition on the structure tensor.

8. The method of claim 1, wherein determining the diffusion tensor comprises weighting the diffusion tensor to preserve structural boundaries from the region of interest.

9. The method of claim 1, wherein the simulated data is determined by performing a computer simulation of the seismic survey using the earth model.

10. The method of claim 1, wherein the seismic image describes the acquired seismic data in the depth-domain.

11. The method of claim 1, wherein the objective function is a regularized objective function that comprises priori information based on the earth model.

12. The method of claim 1, further comprising using the updated earth model to facilitate hydrocarbon exploration or production.

13. The method of claim 1, wherein the earth model comprises one or more of the following elastic properties:
density;
P-velocity (Vp);
S-velocity (Vs);
acoustic impedance;
shear impedance;
Poisson's ratio; or
a combination thereof.

14. The method of claim 1, wherein updating the earth model comprises using a search direction and a step size found by a line search method to update elastic property values in the earth model.

15. A non-transitory computer-readable medium having stored thereon computer-executable instructions which, when executed by a computer, cause the computer to:
receive seismic data for a region of interest, wherein the seismic data is acquired in a seismic survey;
determine a seismic image based at least in part on the acquired seismic data and an earth model for the region of interest;
determine simulated seismic data based at least in part on the earth model;
determine a gradient of an objective function that represents a mismatch between the acquired seismic data and the simulated seismic data;
determine a diffusion tensor using geological information from the seismic image;
update the gradient of the objective function using the diffusion tensor;
update the earth model using the updated gradient; and
use the updated earth model to facilitate hydrocarbon exploration or production.

16. The non-transitory computer-readable medium of claim 15, wherein the computer-executable instructions which, when executed by the computer, cause the computer to determine the diffusion tensor comprises computer-executable instructions which, when executed by the computer, cause the computer to determine a spatial window for the diffusion tensor, wherein the spatial window specifies the corresponding physical dimensions of geological features in the seismic image used in updating the gradient of the objective function.

17. The non-transitory computer-readable medium of claim 15, wherein the diffusion tensor is determined from a structure tensor of the seismic image.

18. The non-transitory computer-readable medium of claim 17, wherein the computer-executable instructions which, when executed by the computer, cause the computer to determine the diffusion tensor comprises computer-executable instructions which, when executed by the computer, cause the computer to perform an eigen-decomposition on the structure tensor.

19. The non-transitory computer-readable medium of claim 15, wherein the computer-executable instructions which, when executed by the computer, cause the computer to determine the diffusion tensor comprises computer-executable instructions which, when executed by the computer, cause the computer to weight the diffusion tensor to preserve structural boundaries from the region of interest.

20. A method, comprising:
receiving survey data for a multi-dimensional region of interest, wherein the survey data is acquired in an imaging procedure;
determining an image by migrating the survey data into the spatial domain using a model of the multi-dimensional region of interest;
determining simulated survey data based at least in part on the model;
determining an objective function that represents a mismatch between the survey data and the simulated survey data;
determining a diffusion tensor using information obtained from the image; and
updating the model for the multi-dimensional region of interest using the diffusion tensor with the objective function.
